(19) United States
(12) Patent Application Publication
(10) Pub. No.: US 2003/0017435 A1
(43) Pub. Date: Jan. 23, 2003

(54) Method and system for tooth whitening for long term efficacy

(76) Inventors: Robert L. Ibsen, Santa Maria, CA (US); Kelly Smith-Reynolds, San Luis Obispo, CA (US); William R. Glace, Santa Maria, CA (US)

Correspondence Address: John W. Ryan, WILMER CUTLER & PICKERING, 2445 M. Street, N.W., Washington, DC, 20037-1420, US

(21) Appl. No.: 09/906,826

(22) Filed: Jul. 18, 2001

(51) Int. Cl. A61C 5/00

(52) U.S. Cl. 433/215

(57) ABSTRACT

A method and system for whitening teeth using at least a whitening gel, a whitening toothpaste, and a whitening rinse. Preferably the system employs a predetermined weight percentage of a peroxide based bleaching agent to effect tooth whitening. In certain formulations the components may use carbamide peroxide or hydrogen peroxide as a bleaching agent. The system may be used at home and preferably does not require clinical visits. The method includes the steps of brushing the teeth daily and before each bleaching with a whitening toothpaste, bleaching the teeth with a whitening gel twice daily, and rinsing with a whitening rinse. Daily brushing with a whitening toothpaste and preferably rinsing with a whitening rinse follow these whitening treatments. A system or kit for whitening teeth includes all of the components necessary to follow the aforementioned method, including a whitening gel, whitening toothpaste, a whitening rinse, and one or more mouth guard trays.

### TECHNICAL FIELD

The present invention relates generally to dental compositions and methods for treating teeth surfaces. More particularly, the present invention relates to tooth whitening and to methods and systems for whitening teeth.

### BACKGROUND ART

Many people consider darkened or stained teeth undesirable. To correct this condition, people often have veneers placed over their teeth or have their teeth bleached using chemical treatments. Tooth bleaching is often used to lighten or whiten the color of teeth that are darkened due to intrinsic and extrinsic discoloration. This discoloration may be attributed to flourosis, chemical staining, non-vital teeth, tetracycline, or aging.

The dental profession has expressed a growing interest in home-based tooth bleaching products and methods. These techniques avoid the patients having to visit a clinic for treatment. The effectiveness of these treatments depends on a variety of factors such as the type and intensity of the stain, bleaching agent contact time on teeth, and the amount of active ingredient in the bleaching agent. Since the time for the treatment in a home-based system is outside the clinical setting, the total treatment costs are significantly lessened and patient discomfort associated with home-based bleaching techniques are typically less than that associated with clinical in-office bleaching or whitening.

Peroxide-based bleaching systems for teeth have been marketed previously. Most of the systems include a bleaching agent with carbamide peroxide in a thickened glycerin base or carrier. The systems typically require a user to place the bleaching agent in a mouth guard and wear the mouth guard for from 30 minutes per day to overnight. A more recent version utilizes adhesive strips with a hydrogen peroxide gel attached. The strips are then adhered to the tooth surface for bleaching. With any of these bleaching systems there is certain amount of recidivism once active bleaching is stopped. Thus, although initial results may be favorable, whitened teeth often quickly become stained or darkened again. A need exists for a tooth whitening system that works to avoid the relapses to darkened or stained teeth.

### SUMMARY

In one embodiment, the invention is a method for teeth whitening comprising brushing the teeth daily and before each bleaching with a whitening toothpaste, bleaching the teeth with a whitening gel twice daily, and rinsing with a whitening mouth rinse. Once a predetermined amount of bleach is used, or, the desired level of whitening is achieved, a patient continues brushing with the whitening toothpaste twice daily, and if desired, continues use of the whitening rinse. Continued use of these whitening compounds helps to prevent recidivism and in fact, additional whitening may take place beyond the initial bleaching period.

In another embodiment, the invention is a kit for teeth whitening comprising a whitening toothpaste, whitening gel, whitening rinse, and one or more mouth guard trays.

Additional advantages and novel features of the present invention will be set forth in part in the description which follows and in part will become apparent to those skilled in the art upon examination of the following or may be appreciated further by practice of the invention.

### BRIEF DESCRIPTION OF THE DRAWING

Features and advantages of the present invention will become apparent to those skilled in the art from the following description with reference to the drawing, in which:

FIG. 1 is a block diagram of a system for teeth whitening.

### DETAILED DESCRIPTION

For simplicity and illustrative purposes, the principles of the present invention are described by referring mainly to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the true spirit and scope of the present invention. Before explaining the disclosed embodiments of the present invention in detail, is to be understood that the invention is not limited in its application to the details of any particular arrangement shown, since the invention is capable of other embodiments. The terminology used herein is for the purpose of description and not of limitation.

In one embodiment, the invention includes a method for teeth whitening. The method includes thoroughly brushing the teeth to be whitened with a whitening toothpaste to clean and prepare the surface of the teeth so they will be ready for bleaching. The whitening toothpaste preferably includes carbamide peroxide in a concentration of about nine percent by weight. The whitening toothpaste is additionally used a minimum of twice daily during the whitening treatment period, and afterwards to decrease recidivism or tooth darkening and/or staining following the tooth whitening treatment. As previously described, brushing with the whitening toothpaste may lead to additional whitening, in addition to preserving the whitening achieved when the whitening gel treatment is stopped.

The method also includes a bleaching step wherein the teeth to be whitened are bleached with a whitening gel. The whitening gel preferably includes carbamide peroxide in a concentration of about ten percent by weight. The bleaching step includes applying a layer of the whitening gel to a mouth guard. Preferably, two mouth guards are used to provide separate upper and lower trays for the upper and lower teeth, respectively. Once a suitable layer of whitening gel is applied to a mouth guard, the mouth guard is applied to the teeth so that the whitening gel directly contacts the teeth. The mouth guards are preferably worn in this manner for 20-30 minutes during each bleaching. The bleaching treatment period is preferably about four weeks long, with bleaching being performed twice daily. The mouth guards may be worn for a longer period of time during each treatment for even greater whitening. The mouth guards are preferably cleaned after each use.

Another step in the method involves rinsing the mouth with a whitening rinse. Preferably, the whitening rinse includes a peroxide agent, and in one embodiment the peroxide agent is hydrogen peroxide in a total concentration of about 1.5%. The whitening rinse may also include antibacterial agents to help prevent tooth decay and fight cavities. The whitening rinse may include breath freshening agents to prevent halitosis as well as agents to make the whitening rinse more palatable for the user. The whitening rinse is preferably used after each bleaching with the whitening gel. Alternatively, the whitening rinse may be used less, or especially more often as desired by the user.

Once the bleaching treatment period expires, or the patient reaches the desired level of whitening, the bleaching treatments should stop, and the patient continues brushing twice daily with the whitening toothpaste. The patient may also continue rinsing with the whitening rinse. Continued use of the whitening toothpaste and whitening rinse help to ensure that the teeth do not relapse into staining or other darkening as often occurs without the follow-up brushing with a whitening toothpaste and rinsing with a whitening rinse.

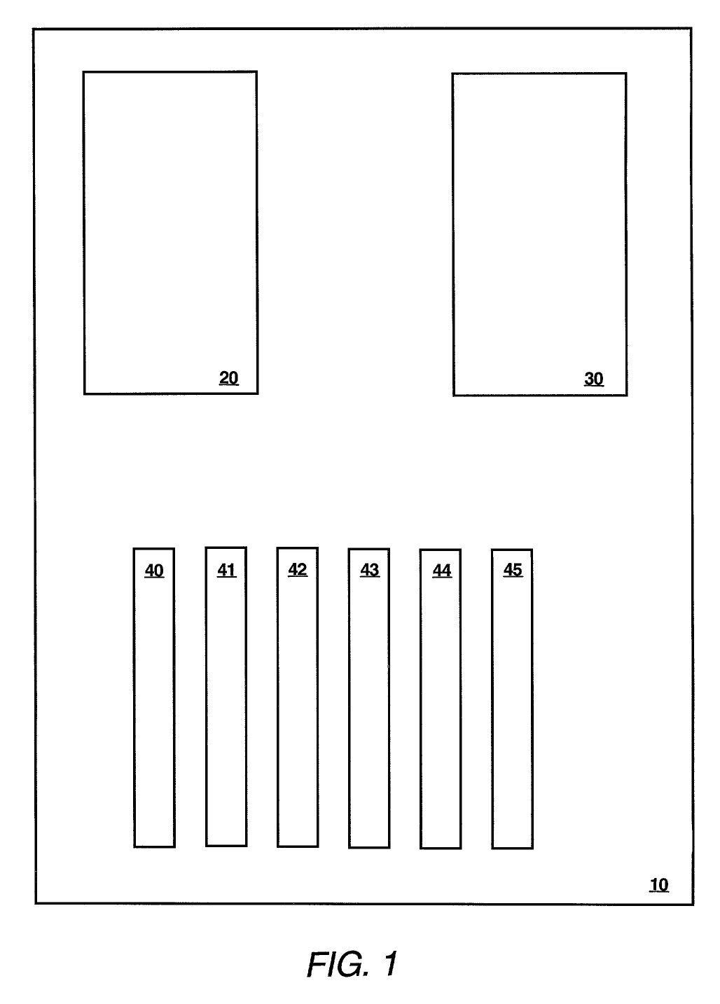

FIG. 1 depicts a block diagram of a system for teeth whitening 10. As shown in FIG. 1, the system for teeth whitening 10 includes a whitening toothpaste 20, a whitening rinse 30, and six units of whitening gel 40, 41, 42, 43, 44, 45. It should be appreciated that the whitening gel is divided into six separate units for convenience and to help ensure that the whitening gel does not spoil once it is opened, since use of the gel is contemplated over a period of time. In one embodiment the whitening gel is distributed among a group of syringes to facilitate easy and accurate placement of the layer of whitening gel within a mouth guard. The whitening gel includes a bleaching agent that is preferably selected from the family of peroxide-based bleaching agents. In one embodiment, the peroxide agent is carbamide peroxide and is present in an amount from about 4% to about 30% carbamide peroxide by weight. In a more preferred embodiment, the carbamide peroxide concentration is about 10% carbamide peroxide by weight. It should be appreciated that the higher concentrations of carbamide peroxide may be reserved for the clinical setting and administered by properly trained individuals. The whitening gel is preferably packaged within a predetermined number of resealable containers, whose total number may be larger or smaller than that shown in FIG. 1, in accordance with the particular use contemplated. In the embodiment depicted in FIG. 1, 18 milliliters of whitening gel are distributed into 3-milliliter aliquots and packaged in a resealable container to help prevent contamination and spoilage (such as by drying out) of the whitening gel between uses. This amount may be increased or decreased as necessary for each particular application.

The whitening toothpaste 20 is preferably packaged in a resealable container so as to prevent contamination and spoilage (such as by drying out) of the whitening toothpaste 20. The whitening toothpaste 20 includes a bleaching agent that is preferably selected from the family of peroxide-based bleaching agents. In one embodiment, the peroxide agent is carbamide peroxide. The carbamide peroxide is preferably in an amount between about 5 and 15% by weight and even more preferably in an amount of about 9% carbamide peroxide by weight. The whitening toothpaste 20 may also include a fluoride compound to fight cavities as well as compounds intended to reduce plaque and tarter. The whitening toothpaste 20 may also include one or more compounds to help provide fresh breath and fight halitosis. In the embodiment depicted in FIG. 1 the whitening toothpaste 20 is provided in an amount of approximately 2.5 ounces.

The whitening rinse 30 is preferably packaged in a resealable container so as to prevent contamination and spoilage (such as by drying out) of the whitening rinse 30. The whitening rinse 30 includes a bleaching agent that is preferably selected from the family of peroxide-based bleaching agents. In one embodiment, the peroxide agent is hydrogen peroxide and is in an amount between about 0.5 and 1.5% by weight and more preferably in an amount of about 1.5% hydrogen peroxide by weight. The whitening rinse may also include antibacterial agents to help prevent tooth decay and fight cavities. The whitening rinse may include breath freshening agents to prevent halitosis as well as agents to make the whitening rinse more palatable for the user. In the embodiment depicted in FIG. 1, the whitening rinse 30 is provided in an amount of approximately four ounces.

The system for teeth whitening 10 may also include a mouth guard (not shown) for the upper and lower teeth. Preferably, the system includes multiple mouth guards (not shown), one for the upper and one for the lower teeth. Preferably, the mouth guards are of a sort that will conform to the teeth upon heating so that the user can get a comfortable and conforming fit that reflects the contours of the user's teeth. A layer of whitening gel is placed within the mouth guard and the mouth guard is used to hold the whitening gel against the teeth while the mouth guard is worn for the desired period of time.

While the invention has been described with reference to certain exemplary embodiments thereof, those skilled in the art may make various modifications to the described embodiments of the invention without departing from the true spirit and scope of the invention. The terms and descriptions used herein are set forth by way of illustration only and not meant as limitations. In particular, although the present invention has been described by examples, a variety of devices would practice the invent concepts described herein. All the invention has been described and disclosed in various terms and certain embodiments, the scope of the invention is not intended to be, nor should be deemed to be, limited thereby and such other modifications or embodiments as may be suggested by the teachings herein are particularly reserved, especially as they fall within the breadth and scope of the claims here appended. Those skilled in the art will recognize that these and other variations are possible within the spirit and scope of the invention as defined in the following claims and their equivalents.

We claim:

1. A method of teeth whitening comprising the steps of:
brushing the teeth twice daily and before each bleaching with a whitening toothpaste;
bleaching the teeth with a whitening gel daily for about four weeks;
rinsing with a whitening rinse; and
repeating the brushing with a whitening toothpaste step after the last bleaching step.

2. The method of claim 1 further comprising:
repeating the rinsing with a whitening rinse step daily after the last bleaching step.

3. The method of claim 1 wherein the whitening toothpaste comprises from about 5 to about 15% carbamide peroxide by weight.

4. The method of claim 1 wherein the whitening toothpaste comprises about 9% carbamide peroxide by weight.

5. The method of claim 1 wherein the whitening gel comprises from about 4 to about 30% carbamide peroxide by weight.

6. The method of claim 1 wherein the whitening gel comprises about 10% carbamide peroxide by weight.

7. The method of claim 1 wherein the whitening rinse comprises from about 0.5% to about 1.5% by weight.

8. The method of claim 1 wherein the whitening rinse comprises about 1.5% hydrogen peroxide by weight.

9. The method of claim 1 wherein the whitening gel is used in the bleaching step for approximately 20-30 minutes per application.

10. The method of claim 1 wherein the bleaching step is repeated twice daily for about four weeks.

11. A kit for teeth whitening comprising:
a whitening toothpaste;
a whitening gel;
a whitening rinse; and
one or more mouthguard trays.

12. The kit for teeth whitening of claim 11 wherein the whitening toothpaste comprises from about 5 to about 15% carbamide peroxide by weight.

13. The kit for teeth whitening of claim 11 wherein the whitening toothpaste comprises about 9% carbamide peroxide by weight.

14. The kit for teeth whitening of claim 11 wherein the whitening gel comprises from about 4 to about 30% carbamide peroxide by weight.

15. The kit for teeth whitening of claim 11 wherein the whitening gel comprises about 10% carbamide peroxide by weight.

16. The kit for teeth whitening of claim 11 wherein the whitening rinse comprises from about 0.5% to about 1.5% by weight.

17. The kit for teeth whitening of claim 11 wherein the whitening rinse comprises about 1.5% hydrogen peroxide by weight.

18. The kit for teeth whitening of claim 11 wherein the whitening toothpaste is present in the amount of approximately 2.5 ounces.

19. The kit for teeth whitening of claim 11 wherein the whitening rinse is present in the amount of approximately 4 ounces.

20. The kit for teeth whitening of claim 11 wherein the whitening gel is present in the amount of approximate 18 milliliters.

21. A method for preventing darkening relapse of teeth comprising the steps of:
bleaching the teeth with a whitening gel;
rinsing with a whitening rinse; and
brushing with a whitening toothpaste.
